(19) United States
(12) Patent Application Publication
(10) Pub. No.: US 2025/0338270 A1
(43) Pub. Date: Oct. 30, 2025

(54) METHODS, ARCHITECTURES, APPARATUSES AND SYSTEMS FOR CONFIGURED GRANT UPLINK HARQ OPERATION WITH NETWORK CODING

(71) Applicant: InterDigital Patent Holdings, Inc., Wilmington, DE (US)

(72) Inventors: Yifan Li, Conshohocken, PA (US); Ayesha Ijaz, Guildford (GB); Faris Alfarhan, Montréal (CA); Pascal Adjakple, Great Neck, NY (US); Ghyslain Pelletier, Montréal (CA)

(21) Appl. No.: 18/645,584

(22) Filed: Apr. 25, 2024

(51) Int. Cl. H04W 72/1268; H04L 1/1607; H04L 5/00; H04W 72/23

(52) U.S. Cl. CPC H04W 72/1268; H04L 1/1642; H04L 5/0053; H04W 72/23

(57) ABSTRACT

A method, implemented in a wireless transmit receive unit (WTRU) is described. The method may include transmitting a set of network coded protocol data units (NC-PDUs) of a network coding (NC) generation in one or more transmit occasions of a configured grant (CG) period. The method may include transmitting NC related information associated with the NC generation to assist a network in decoding. In various embodiments, the NC related information may indicate a number of NC-PDUs of the NC generation to be transmitted in the one or more transmit occasions of the CG period. The method may include monitoring to receive feedback information from the network for the NC generation and transmitting one or more subsequent sets of NC-PDUs from the NC generation in one or more subsequent CG periods until the feedback information acknowledging a reception of the NC generation may be received from the network.

### TECHNICAL FIELD

The present disclosure is generally directed to the fields of communications, software and encoding, including methods, architectures, apparatuses, and systems directed to configured grant uplink hybrid automatic repeat request (HARQ) operation with network coding.

### BACKGROUND

Network coding is a packet processing function that transforms X input packet(s) into Y output packet(s). A receiver receiving at least X out of Y transmitted coded packets may be able to recover the transmitted information. Embodiments described herein have been designed with the foregoing in mind.

### SUMMARY

Methods, architectures, apparatuses, and systems directed to configured grant uplink hybrid automatic repeat request (HARQ) operation with network coding are described herein. In an embodiment, a wireless transmit/receive unit (WTRU) is described. The WTRU may include circuitry including any of transmitter, a receiver, a processor, and a memory. The circuitry may be configured for transmitting a set of network coded protocol data units (NC-PDUs) of a network coding (NC) generation in one or more transmit occasions of a configured grant (CG) period. The circuitry may be configured for transmitting NC related information associated with the NC generation to assist a network in decoding. In various embodiments, the NC related information may indicate a number of NC-PDUs of the NC generation to be transmitted in the one or more transmit occasions of the CG period. The circuitry may be configured for monitoring to receive feedback information from the network for the NC generation and for transmitting one or more subsequent sets of NC-PDUs from the NC generation in one or more subsequent CG periods until the feedback information acknowledging a reception of the NC generation may be received from the network. In various embodiments, the one or more subsequent sets of NC-PDUs may comprise different NC-PDUs from the set of transmitted NC-PDUs.

In an embodiment, a method implemented in a WTRU is described. The method may include transmitting a set of network coded protocol data units (NC-PDUs) of a network coding (NC) generation in one or more transmit occasions of a configured grant (CG) period. The method may include transmitting NC related information associated with the NC generation to assist a network in decoding. In various embodiments, the NC related information may indicate a number of NC-PDUs of the NC generation to be transmitted in the one or more transmit occasions of the CG period. The method may include monitoring to receive feedback information from the network for the NC generation and transmitting one or more subsequent sets of NC-PDUs from the NC generation in one or more subsequent CG periods until the feedback information acknowledging a reception of the NC generation may be received from the network. In various embodiments, the one or more subsequent sets of NC-PDUs may comprise different NC-PDUs from the set of transmitted NC-PDUs.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of network coding as a protocol in the packet data convergence protocol (PDCP);

FIG. 3 is a diagram illustrating an example method for selection and transmission and/or retransmission of network coding protocol data units (NC PDUs); and

FIG. 4 is a diagram illustrating an example method for CG UL HARQ operation with network coding.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

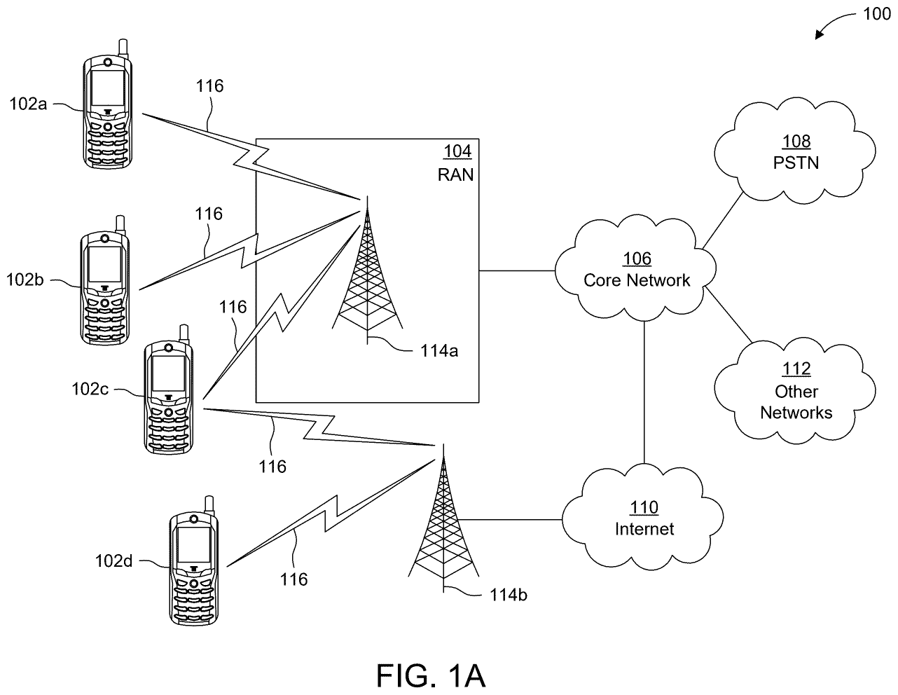

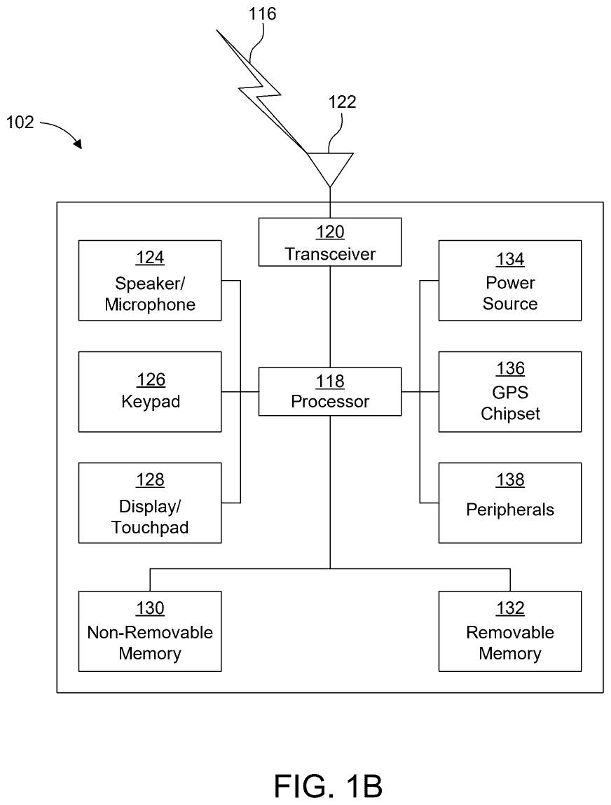

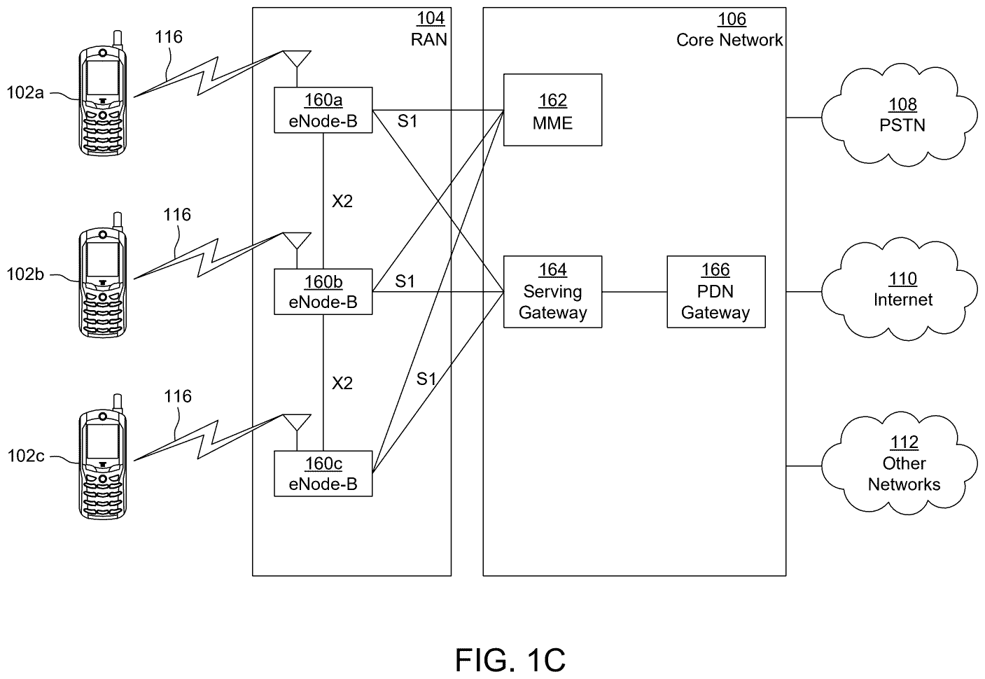

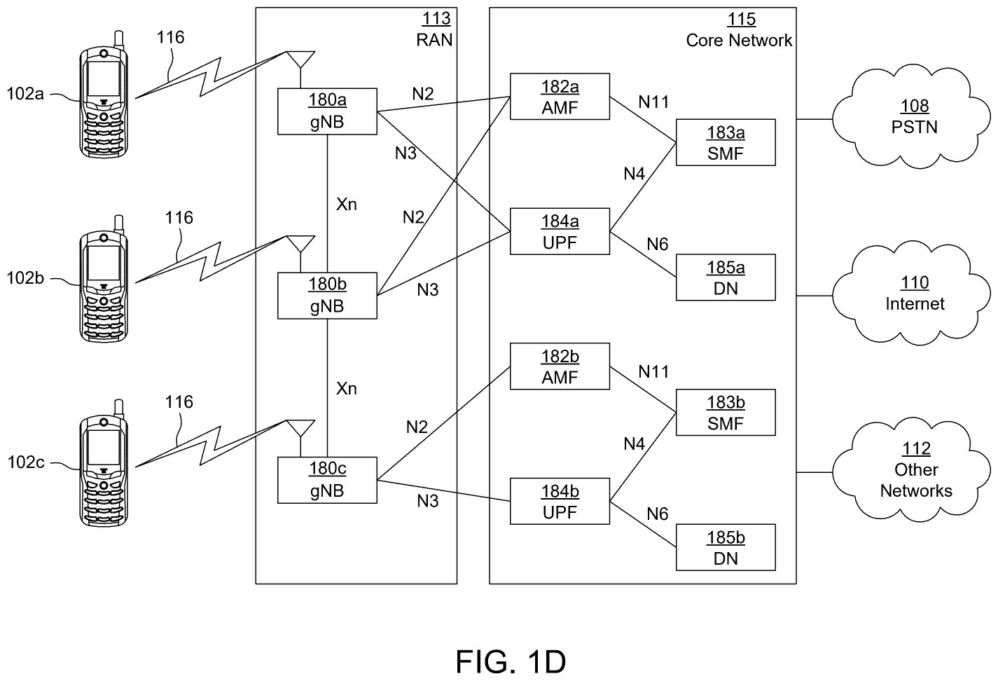

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

### Network Coding

Network coding is a packet processing function that transforms X (e.g., a first number of) input packet(s) (which may also be referred to as source packets) into Y (e.g., a second number of) output packet(s), which may be referred to herein as coded packet(s). In an example, X may be greater or equal to two and Y may be greater or equal to X, with the case where X equal to one and Y equal to one being a specific case. The X input packets being coded together may form a network coding generation (referred to herein as a generation). In an example, one of (e.g., any of) the Y output packets may be obtained based on (e.g., a coding process performing) a linear combination of (e.g., any of) the X input packets.

From the receiver perspective, receiving at least X out of Y transmitted coded packets, may allow the receiver to recover the transmitted information. In some examples, if the transmission of some of the coded packets fails, the (e.g., whole) transmission may succeed (e.g., be recovered).

In new radio (NR), there may be one independent HARQ entity per serving cell and one transport block may be generated per assignment/grant per serving cell. The MAC entity may include a HARQ entity for each serving cell, which may maintain a number of parallel HARQ processes. A (e.g., each) HARQ process may be associated with a HARQ process identifier.

In NR, there may be no explicit HARQ ACK feedback for configured grant (CG) physical uplink shared channel (PUSCH), e.g., transmitted by the gNB. A WTRU may determine whether the PUSCH is successfully delivered or not based on whether the WTRU gets a retransmission request from a gNB or not. If the gNB does not send any dynamic grant (e.g., information) indicating a retransmission request for a HARQ process within a (e.g., pre-configured) time, the WTRU may assume (e.g., determine) that the PUSCH transmission may be (e.g., successfully) received and decoded by the gNB.

In an example, the WTRU may receive (e.g., radio resource control (RRC)) configuration information indicating a number of repetitions to be performed, which may be referred to herein as repK. A value of repK greater than one may indicate that repetitions may be performed for the transport blocks (TBs) such that a (e.g., each TB) may be (e.g., repeatedly) transmitted for a number of times equal to repK. In an example, a CG period may comprise a plurality of transmit occasions (TOs). The WTRU may perform a repetition of a same transport block in the plurality of TOs based on repK (e.g., until the value of repK may be reached). In an example, the transmission of the repetition of TBs may (e.g., start to) be performed in the first TO of the CG period. In another example, the WTRU may be configured with a pattern of redundancy versions (RV), e.g., “0, 1, 3, 4” associated with a plurality of TOs in the CG period, and the transmission of the repetition of TBs may begin at any TO associated with the RV zero in the CG period.

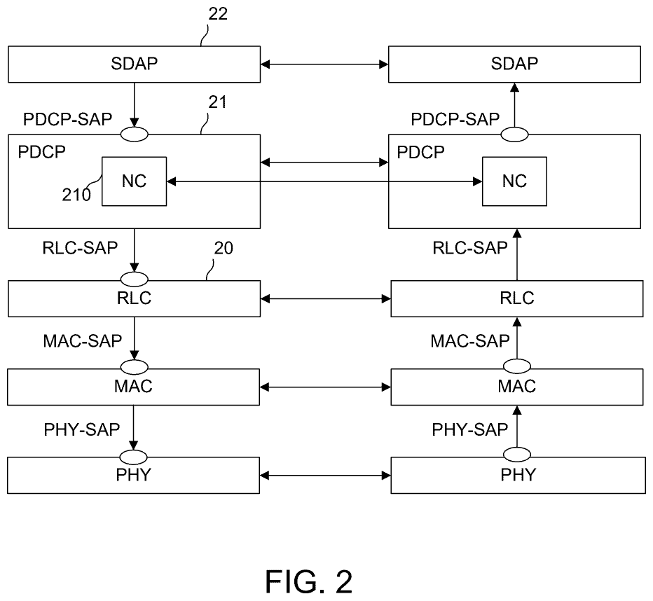

FIG. 2 is a diagram illustrating an example of network coding as a protocol in the packet data convergence protocol (PDCP). A network coding (NC) 210 encoder/decoder may be included in a PDCP layer 21 between a radio link control layer (RLC) 20 and a service data adaptation protocol (SDAP) 22 layer.

The introduction of NC in PDCP, as shown in FIG. 2, may lead to increase the HARQ retransmission overhead, and (e.g., overall) transmission delay incurred at the HARQ level based on transmitting more packets (e.g., Y packets may be transmitted and not X with Y≥X). Embodiments described herein may allow to enhance UL HARQ operation with network coding in PDCP leveraging the fact that (e.g., only) X out of Y transmitted packets may (e.g., need to) be successfully received at the receiver.

For example, NC PDUs from the same NC generation (or different NC generation) may be multiplexed into one or more transport blocks (TBs) based on their characteristics (e.g., type and/or importance levels). In this case different TBs may carry correlated/dependent NC PDUs. Embodiments described herein may allow a transmitting (Tx) WTRU to determine when to transmit NC PDUs for a new NC generation, when to transmit new NC PDUs for the current NC generation, and when to retransmit NC PDUs with redundancy version (RV) for the current NC generation in the PUSCH.

For the sake of clarity, embodiments are described herein with the example of a NC encoder/decoder being included in a PDCP layer. Embodiments are not limited to NC encoder/decoder included in a PDCP layer. Inclusion of a NC encoder/decoder in any protocol layer able to transmit and receive any kind of packet/data may be applicable to embodiments described herein.

For the sake of clarity, embodiments are described herein with the example of network coding for increasing the robustness of transmissions. Embodiments are not limited to network coding and any kind of source/channel/error coding capable to add redundancy to transmitted information to be used at the receiving side to recover the information may be applicable to embodiments described herein.

Overview of Enhanced TB-Based HARQ Processing for Configured Grant UL with NC

A method for enhanced TB-based HARQ processing for configured grant UL with NC located above HARQ is described herein.

For CG UL transmission, the method described herein may allow a WTRU to determine how to perform (re) transmission of NC PDUs to improve cell capacity leveraging the fact that (e.g., only) X out of Y transmitted packets may (e.g., need to) be successfully received at the receiver.

In an example, the WTRU may transmit uplink control information (UCI) carrying the NC related information in the configured grant resource to assist the gNB decoding. If the RRC parameter repK is configured to be greater than one, the WTRU may transmit new (e.g., not yet transmitted, subsequent) NC PDUs for the (e.g., current) NC generation in replacement of a repetition of a previously transmitted transport block. The WTRU may continue to transmit new NC PDUs using configured grant resources until an acknowledgement (ACK) may be received from the gNB.

In an example, a WTRU may be configured to apply network coding (NC) in the physical uplink shared channel (PUSCH) transmission, where the NC PDUs generated from a same (e.g., first) NC generation may be transmitted using one or more TBs.

In a first step, the WTRU may determine and use the configured grant PUSCH to transmit the NC PDUs generated from a (e.g., first) NC generation, e.g., in a (e.g., first) CG period. In addition to the PUSCH, the WTRU may (e.g., also) transmit UCI carrying the NC related information in the configured grant resource to assist the gNB decoding. The UCI may carry one or more of following NC related information: (i) an identifier or a sequence number of the (e.g., first) NC generation, (ii) a number of NC PDUs to be transmitted in the associated configured grant PUSCH, (iii) a first (e.g., total) number of NC PDUs for the (e.g., first) NC generation that the WTRU may (e.g., plan to) transmit to the gNB, (iv) a second (e.g., minimum, lower bound) number of NC PDUs that may allow to (e.g., be required to) decode the NC service data units (SDUs) of the (e.g., first) NC generation, and (v) an indication of whether the configured grant PUSCH is transmitting the NC PDUs for a new NC generation, e.g., through (e.g., based on) new generation indication (NGI) field.

In a second step, if the RRC parameter repK is configured to be greater than one, (e.g., instead of repeating the same TB in the repetitions), the WTRU may transmit new (e.g., not yet transmitted) NC PDUs for the (e.g., current, first) NC generation in the CG PUSCHs (e.g., the TOs associated with the repetitions).

In a third step, e.g., while using the configured grant PUSCH to transmit the NC PDUs (e.g., in one or more subsequent CG periods), the WTRU may monitor the feedback for the (e.g., current, first) NC generation from the gNB. The WTRU may continue to transmit new (e.g., not yet transmitted) NC PDUs for the (e.g., current, first) NC generation using configured grant resources until (e.g., feedback information indicating) an ACK may be received from the gNB. When an ACK, which may be associated (e.g., one-to-one mapped) with the (e.g., first) NC generation, is received by the WTRU, the WTRU may determine the associated NC generation to be successfully received by the gNB and may flush (e.g., all) buffers for this (e.g., first) NC generation.

### Terminology

In embodiments described herein, a NC-SDU may refer to an input data unit to at least the network coding process, and a NC-PDU may refer to an output data unit of at least the network coding process. In embodiments described herein a (e.g., NC, input) data unit may refer to any of a NC-SDU and a NC-SDU segment.

In embodiments described herein a NC generation may refer to (e.g., may comprise) a first plurality of (e.g., X) data units to be coded together (e.g., based on different linear combinations of the data units) to form a second plurality of (e.g., Y) NC-PDUs. In an example, NC PDUs may differ from one another based on different NC PDUs being the result of different linear combinations of one or more data units of a NC generation. For example, a first NC PDU may be the output of a coding process that may perform a linear combination of one or more data units of a NC generation using a first set of coefficients, and a second NC PDU may be the output of a coding process that may perform a linear combination of one or more data units of the NC generation using a second set of coefficients, the first set of coefficients and the second set of coefficients being different.

In embodiments described herein, “current NC generation”, “first NC generation” and “ongoing NC generation”, collectively “NC generation” may be used interchangeably to refer to the NC generation whose (e.g., one or more) associated NC PDUs may have been transmitted in PUSCH using previously scheduled resources and the WTRU may await the HARQ ACK/NACK feedback for its NC PDUs.

In embodiments described herein, “new NC generation” may refer to a NC generation whose associated NC PDUs may not have been transmitted in PUSCH yet.

In embodiments described herein, “new NC PDUs” of the current PDU generation may refer to NC PDUs of the current NC generation that may not have been transmitted in PUSCH yet. The terms “new NC PDUs”, “not yet transmitted NC PDUs”, “subsequent NC PDUs” may be used interchangeably in embodiments described herein.

In embodiments described herein, segmented-SDU based NC may refer to a network coding scheme where NC SDUs may be segmented into NC SDU segments, and packet generations may comprise (e.g., only) NC SDU segments. Re-assembly of NC SDU segments may be performed at the end destination (decoder) to form the original NC SDU.

In embodiments described herein, cross-SDUs based NC SDU concatenation-based NC may refer to a network coding scheme where packet generations may comprise (e.g., only) non-segmented SDUs.

In embodiments described herein, hybrid segmented-SDU based NC or cross-SDUs based NC may refer to a network coding scheme where a generation may comprise NC SDUs or NC SDU segments. This scheme may be referred to as hybrid NC.

In embodiments described herein, the terms “transmission period” and “CG period” may be used interchangeably.

In embodiments described herein a WTRU being “configured with” may refer to the situation where the WTRU may receive information indicating the configuration from the gNB or another network element (e.g., group coordinator WTRU). For the case where the WTRU receives configuration from the gNB, the WTRU may receive a dedicated RRC configuration and/or a system information block (SIB) from the gNB. For the case where the WTRU receives configuration from another network element, the WTRU may receive configuration via sidelink communication (e.g., PC5 RRC).

In embodiments described herein, the WTRU being “configured” or “(pre)-configured” to perform an action may refer to the situation where the WTRU may be, for example, hard coded to perform the action via e.g., standard specifications.

Embodiments described herein are based on the assumption that a MAC/HARQ entity may know about how NC SDUs may be coded and the corresponding NC PDUs.

In an example, a MAC/HARQ entity may know any of (i) a NC generation e.g., NC SDUs coded together, and the NC generation identifier or sequence number associated with a (e.g., each) NC generation, (ii) NC PDUs associated with the same NC generation (for example, MAC or HARQ entity may receive from upper layers, the NC generation identifier associated with a (e.g., each) NC PDU, and (iii) an importance and/or characteristics (e.g., any of systematic packet, innovative packet, erasure correction packet or error correction packet, etc.) of a (e.g., each) NC PDU.

In an example, a (e.g., each) TB may carry one or more NC PDUs from one or more NC generations.

### Enhanced TB-based HARQ Processing for Configured Grant UL

Enhanced TB-based HARQ processing for configured grant UL is described herein.

### Transmission of Assistance Information to the gNB for Decoding

Transmission of assistance information to the gNB for decoding is described herein.

### NC Related Information Transmission via UCI

NC related information transmission via UCI is described herein.

### Example of WTRU Transmitting UCI Carrying the NC Related Information in CG Resource(s) to Assist the gNB Decoding

A WTRU may transmit uplink control information (UCI) carrying the NC related information in configured grant (CG) resource(s) to assist the gNB decoding.

In an example, the WTRU may transmit NC related information in UCI, which may be referred to as NC CG-UCI, to assist any of the gNB decoding scheduling (e.g., trigger retransmission of NC PDUs, schedule additional NC PDU transmission etc.) and feedback decisions (e.g., indicating ACK for an NC generation etc.). The WTRU may transmit information in NC CG-UCI to determine (e.g., indicate) one or more of (i) an identifier and sequence number of NC generation, (ii) a number of NC PDUs to be transmitted in configured grant PUSCH, (iii) a total number of NC PDUs for the NC generation that the WTRU may (e.g., plan to) transmit to the gNB, (iv) a NC SDU or NC PDU size, (v) a (e.g., minimum, lower bound) number of NC PDUs that may allow (e.g., be required) to decode the NC SDUs of an NC generation, (vi) an indication of whether the configured grant PUSCH may be transmitting the NC PDUs for a new NC generation, and (vii) a type of PDUs carried in the PUSCH.

In a first example, the WTRU may transmit information in NC CG-UCI to determine (e.g., indicate) an identifier or sequence number of NC generation. For example, a WTRU may be configured to transmit NC PDUs from an NC generation in a transport block (TB) in CG PUSCH and the CG-UCI may indicate an index of the corresponding NC generation. This field may be referred to e.g., NC generation identifier field in UCI. In one approach, the length of this field may be pre-configured e.g., hard coded in specifications or (semi)-statically configured by the network. In another approach, the length of this field may be indicated by the WTRU e.g., as described here below in the example WTRU performing separate channel coding of information elements in CG-UCI. In another approach, the length of this field may be determined based on (e.g., maximum, upper bound) number of NC generations that may be (e.g., allowed to be) multiplexed in a TB in CG PUSCH which may be (pre)-configured for a WTRU. In one example, if the length of the field to indicate identifier for one NC generation is K bits and a WTRU is configured to multiplex (e.g., maximum, upper bound) number of G NC generations in a TB in CG PUSCH, the length of the NC generation identifier field in CG-UCI may be G·K (G multiplied by K) bits. In another example, the WTRU may use a bitmap, with length equal to (e.g., maximum, upper bound) number of NC generations that can be multiplexed in a TB in CG-PUSCH, to indicate identifiers of NC generations whose NC PDUs may be carried in CG-PUSCH. There may be a pre-configured association between an index of a (e.g., each) bit in the bitmap and the NC generation number. An example scenario where this approach may be used is when more than one NC generations may be multiplexed in a TB in CG-PUSCH.

In a second example, the WTRU may transmit information in NC CG-UCI to determine (e.g., indicate) a number of NC PDUs to be transmitted in configured grant PUSCH. For example, a WTRU may be (pre)-configured with the (e.g., maximum, upper bound) number of NC PDUs (referred to herein as Nₘₐₓ) that may be transmitted in a TB in CG-PUSCH. The WTRU may be further configured to transmit log₂ (Nₘₐₓ) bits in CG-UCI to indicate the number of NC PDUs to be transmitted (e.g., referred to as N) in the associated configured grant PUSCH.

In a third example, the WTRU may transmit information in NC CG-UCI to determine (e.g., indicate) a total number of NC PDUs for the NC generation that the WTRU may (e.g., plan to) transmit to the gNB. For example, a WTRU may be (pre)-configured with the (e.g., maximum, upper bound) number of NC PDUs (referred to herein as N_{max,gen}) that may be transmitted from an NC generation in CG-PUSCH. The WTRU may be further configured to transmit log₂ (N_{max,gen}) bits in CG-UCI to indicate the number of NC PDUs it may (e.g., plan to) transmit (referred to as Nₜₒₜₐₗ) in the associated configured grant PUSCH(s) from NC generation.

In a fourth example, the WTRU may transmit information in NC CG-UCI to determine (e.g., indicate) a NC SDU or NC PDU size. For example, the WTRU may indicate a size of NC SDU or NC PDU of an NC generation.

In a fifth example, the WTRU may transmit information in NC CG-UCI to determine (e.g., indicate) a minimum number of NC PDUs for decoding the NC SDUs of an NC generation. For example, a WTRU may indicate the (e.g., minimum, lower bound) number of NC PDUs (e.g., referred to as X) that may allow (e.g., be required to be received) to decode the NC SDUs of an NC Generation. The length of this field may be pre-configured (e.g., hard coded in specifications) and/or (semi)-statically configured by the network. For example, the WTRU may indicate a NC code rate (referred to as R_{NC}) for an NC generation in the CG-UCI. The receiver may determine the (e.g., minimum, lower bound) number of NC PDUs (e.g., X) (e.g., required) to decode the NC SDUs of the NC Generation based on R_{NC} and Nₜₒₜₐₗ e.g., as X=Nₜₒₜₐₗ·R_{NC} (e.g., Nₜₒₜₐₗ multiplied by R_{NC}).

In a sixth example, the WTRU may transmit in NC CG-UCI an indication of whether the configured grant PUSCH may be transmitting the NC PDUs for a new NC generation. For example, the WTRU may indicate whether the configured grant PUSCH may be transmitting the NC PDUs for a new NC generation using a field e.g., new generation indication (NGI) field in the CG-UCI. For example, when the WTRU transmits the NC PDUs associated with a new NC generation in the CG-PUSCH, the WTRU may toggle NGI field. For example, when the WTRU transmits NC PDUs associated with a current NC generation, the WTRU may not toggle NGI field in the associated CG-UCI.

In a seventh example, the WTRU may transmit information in NC CG-UCI to determine (e.g., indicate) a type of PDUs carried in the PUSCH. For example, the WTRU may indicate the type/characteristics of the PDUs (e.g., any of systematic NC PDUs, importance of NC PDUs, innovativeness of NC PDUs etc.) in the CG-UCI.

### Encoding of Information Elements in CG-UCI

Encoding of information elements in CG-UCI is described herein.

### Example of WTRU Performing Joint Channel Coding of Information Elements in CG-UCI

In an example, a WTRU may perform joint channel coding of bits for the information elements in CG-UCI. The WTRU may perform joint channel coding using an error correction coding scheme based on (e.g., total) number of bits to be transmitted in the CG-UCI.

### Example of WTRU Performing Separate Channel Coding of Information Elements in CG-UCI

In another example, a WTRU may perform separate channel coding for one or more information elements in CG-UCI. For example, the WTRU may encode a first set of one or more information elements of CG-UCI separately from a second set of one or more information elements of CG-UCI. The WTRU may send information about the second set of one or more information elements of CG-UCI in the first set of one or more information elements of the CG-UCI. For example, the WTRU may indicate the length of one or more fields in the second set of one or more information elements of CG-UCI in the first set of one or more information elements of the CG-UCI.

### Resources for Transmission of CG-UCI

Resources for transmission of CG-UCI is described herein.

### Example of WTRU Transmitting CG-UCI in CG-PUSCH Resources

In an example, a WTRU may transmit CG-UCI in CG-PUSCH allocation. The WTRU may determine resources for the CG-UCI in CG-PUSCH allocation based on e.g., a pre-defined rule. For example, the WTRU may use pre-configured time and/or frequency resource offset(s) within the CG-PUSCH resources to determine the start position of resources which may be used for transmission of CG-UCI. In another example, the WTRU may use pre-configured time and/or frequency resource offset(s) relative to another signal (e.g., any of another UCI, a reference signal etc.) to determine the start position of resources which may be used for transmission of CG-UCI. Resource elements in the resources which may be used for CG-UCI transmission may be any of contiguous and distributed in time and/or frequency domains.

### Example of WTRU Transmitting CG-UCI in Pre-Configured PUCCH Resources

In an example, a WTRU may transmit CG-UCI in physical uplink control channel (PUCCH) resources which may be pre-configured for CG-UCI transmission. The WTRU may use a pre-configured mapping (e.g., association) between a PUCCH resource configured for CG-UCI transmission and the corresponding CG-PUSCH transmission to determine the information to be sent to the gNB in the CG-UCI.

### Transmission Occasion for Sending CG-UCI

In an example, a WTRU may transmit a CG-UCI for a (e.g., each) transmission of CG-PUSCH carrying NC PDUs associated with an NC generation.

In another example, a WTRU may transmit a CG-UCI for a first number (referred to as K_{CG-UCI} and greater than or equal to one) of CG-PUSCH transmissions carrying NC PDUs associated with an NC generation.

In another example, a WTRU may transmit CG-UCI at pre-configured occasions within a CG period. For example, the WTRU may periodically transmit CG-UCI within a CG transmission period. In another example, the WTRU may transmit CG-UCI at pre-configured RV(s) transmission occasions.

### NC Related Information Transmission Via Other Control Signaling

NC related information transmission via other control signaling is described herein.

### Example of WTRU Transmitting NC Related Information Via L2/L3 Control Signaling e.g., any of MAC CE, RRC Signaling Etc.

In an example, a WTRU may transmit NC related information via layer two (L2) control (e.g., MAC control element (MAC CE), layer three (L3) control (e.g., RRC signaling, RRC message) etc. to assist the gNB decoding. For example, the WTRU may transmit one or more of the following pieces of information to the gNB.

In a first example of piece of information, the WTRU may transmit information indicating a (e.g., maximum, upper bound) number of NC generations and/or their identifiers/sequence numbers whose NC PDUs may be to be transmitted in CG-PUSCH.

In a second example of piece of information, the WTRU may transmit information indicating a mapping (e.g., association) between NC generation identifiers and the HARQ processes. For example, the WTRU may indicate a mapping (e.g., association) between NC generation identifiers and the HARQ processes for the gNB to implicitly determine NC generation identifier based on the identified HARQ process ID of the received PUSCH.

In a third example of piece of information, the WTRU may transmit information indicating a NC generation size e.g., the number of NC SDUs encoded together (for many-to-many mapping between NC SDUs and NC PDUs) or the number of segments of an NC SDU (for one-to-many mapping between NC SDUs and NC PDUs) for a (e.g., each) generation whose NC PDUs may be to be transmitted in CG-PUSCH.

In a fourth example of piece of information, the WTRU may transmit information indicating a (e.g., minimum, lower bound) number of NC PDUs (e.g., required) to decode the NC SDUs of an NC generation (referred to as X).

In a fifth example of piece of information, the WTRU may transmit information indicating a total number of NC PDUs the WTRU may (e.g., plan) to transmit from an NC generation.

In an example, NC related information associated with a NC generation may be transmitted in one or more transmissions in any of UCI, MAC CE and RRC message(s).

Enhanced Repetition within a Transmission Period for CG-PUSCH

Enhanced repetition within a transmission period for CG-PUSCH is described herein.

Example of WTRU Transmitting New NC PDUs at a (e.g., each) Transmission Occasion within a CG Period

In an example, the WTRU may transmit new NC PDUs from an NC generation at a (e.g., each) transmission occasion (e.g., of a plurality of TOs) within a transmission period of configured grant configuration. The WTRU may determine the number of TBs (carrying the new NC PDUs) transmitted within a transmission period based on the RRC configured value of parameter repK which may indicate the number of repetitions K within a CG period.

Example of WTRU Determining which NC PDUs to Transmit Based on RV

In an example, a WTRU may determine whether to transmit new NC PDUs from the current NC generation or perform repetitions of NC PDUs based on the RV associated with the transmission occasion. For example, the WTRU may have received configuration information indicating a RV pattern for one or more CG periods, where a (e.g., each) value of the pattern may indicate a RV value associated with a transmit occasion of a CG period. For example, the WTRU may transmit a TB with new NC PDUs for a (e.g., each) transmission occasion of RV0 (e.g., RV=0 in the pattern). For other values of RV (e.g., RV≠0), the WTRU may perform repetition of NC PDUs (e.g., according to the relevant RV) which were previously transmitted in a TB at the last transmission occasion of RV=0 within the CG period. Considering an example, where the WTRU may be RRC configured with a RV pattern of “0303” for CG. For the first TO in a CG period, the WTRU may transmit a first TB (referred to as TB1) with new NC PDUs based on corresponding RV value being zero for this first TO. At the second PUSCH TO in the CG period, the WTRU may repeat the first TB (TB1) with a different RV e.g., RV=3 (being a repetition of a NC PDU, with a different RV). At the third TO, the WTRU may transmit a new TB (referred to as TB2) with new NC PDUs based on the corresponding RV being zero. In the fourth TO in the CG period, WTRU may repeat TB2 using RV=3 as per RRC configuration.

### Enhanced WTRU Procedures for CG PUSCH

Enhanced WTRU procedures for CG PUSCH are described herein.

### NC PDU Transmission for Current NC Generation Using CG-PUSCH

NC PDU transmission for current NC generation using CG-PUSCH is described herein.

Example of WTRU Transmitting (e.g., all) NC PDUs Associated with an NC Generation Using CG-PUSCH

In an example, a WTRU may transmit (e.g., all) NC PDUs associated with an NC generation using CG-PUSCH resources. The WTRU may continue to transmit new NC PDUs at a (e.g., each) transmission occasion where a WTRU may be able/allowed to transmit new NC PDUs from the current NC generation until a criterion (e.g., condition) to stop transmission of NC PDUs from the current NC generation may be satisfied.

Example of WTRU Transmitting a First Set of NC PDUs Associated with an NC Generation Using CG-PUSCH and Transmitting Remaining NC PDUs Using DG PUSCH

In an example, a WTRU may transmit a first set of one or more NC PDUs associated with an NC generation using CG-PUSCH resources. The WTRU may transmit a second set of (e.g., remaining) NC PDUs associated with the NC generation using dynamically scheduled PUSCH resources (e.g., dynamic grant (DG)). For example, the WTRU may transmit a first set of one or more NC PDUs associated with an NC generation in a transmission period of the CG configuration. If there are remaining NC PDUs associated with the NC generation after transmission of the first set of NC PDUs in the CG-PUSCH, the WTRU may wait to receive scheduling DCI (e.g., DG) for transmission of the remaining NC PDUs in dynamically scheduled PUSCH resources.

Example of WTRU Transmitting Initial Transmission of NC PDUs Associated with an NC Generation using CG-PUSCH and Transmitting Retransmission of NC PDUs Using DG PUSCH

In an example, a WTRU may determine a (e.g., certain) number of NC PDUs to be transmitted and may transmit these NC PDUs through CG-PUSCH. Depending on the channel condition, the gNB may fail to correctly receive and/or decode one or more of the NC PDUs and may fail to recover the NC SDUs. A retransmission may be triggered. The WTRU may retransmit the NC PDUs, e.g., retransmit the (e.g., one or more of the) NC PDUs that may have been transmitted with a different RV and/or may transmit additional new NC PDUs, using the DG PUSCH. The WTRU may wait to receive scheduling DCI for retransmitting the NC PDUs in dynamically scheduled PUSCH resources.

### Criteria to Stop NC PDU Transmission for Current NC Generation

One or more criteria (e.g., conditions) to stop NC PDU transmission for the current NC generation are described herein.

Example of WTRU Stopping Transmission for Current NC Generation after Total Number of NC PDUs Indicated in CG-UCI being Transmitted

In an example, a WTRU may indicate in the CG-UCI the total (e.g., upper bound) number of NC PDUs (e.g., Nₜₒₜₐₗ) the WTRU may intend to transmit, and the WTRU may stop transmission of NC PDUs from current NC generation after transmission of Nₜₒₜₐₗ NC PDUs from the NC generation. For example, the WTRU may continue transmitting new NC PDUs from an NC generation at a (e.g., each) transmission occasion in a (e.g., each) CG transmission period (as described herein in the example of WTRU transmitting new NC PDUs at a (e.g., each) transmission occasion within a CG period) until Nₜₒₜₐₗ NC PDUs from the NC generation may be transmitted. In another example, the WTRU may continue transmission/repetition of NC PDUs from an NC generation in a (e.g., each) CG transmission period (as described herein in the example of WTRU determining which NC-PDUs to transmit based on RV) until Nₜₒₜₐₗ NC PDUs from the NC generation may be transmitted.

Example of WTRU Stopping Transmission for Current NC Generation after Receiving Explicit ACK

In an example, a WTRU may terminate transmission of NC PDUs from the current NC generation based on (e.g., upon) reception of explicit ACK (e.g., feedback information) from the gNB indicating successful reception of an amount of NC PDUs allowing to decode the NC SDUs associated with the NC generation. For example, a WTRU may continue to transmit new NC PDUs for the current NC generation using CG PUSCH resources until (e.g., feedback information indicating) an ACK may be received from the gNB. When (e.g., after) an ACK may be received, the WTRU may determine that the associated NC generation may have been successfully received by the gNB and may flush (e.g., all) buffers for this NC generation. The WTRU may receive the explicit ACK (e.g., feedback information) for termination of NC PDU transmission in any of layer one (L1) control signaling e.g., DCI and layer two (L2) control signaling e.g., MAC CE. In one example, the received control signaling may indicate the NC generation identifier (e.g., explicitly) for the WTRU to determine which buffers may be flushed. In another example, the NC generation may be identified implicitly. For example, there may be a (e.g., mother, parent) HARQ process associated with a (e.g., each) NC generation and receiving DCI carrying ACK signaling for the mother HARQ process may implicitly indicate ACK for the corresponding (e.g., associated) NC generation.

Method for CG UL HARQ Operation with Network Coding

An example of a realization of WTRU processing for selection and transmission and/or retransmission of NC PDUs when the WTRU uses configured grant PUSCH to transmit NC PDUs associated with an NC generation is described herein.

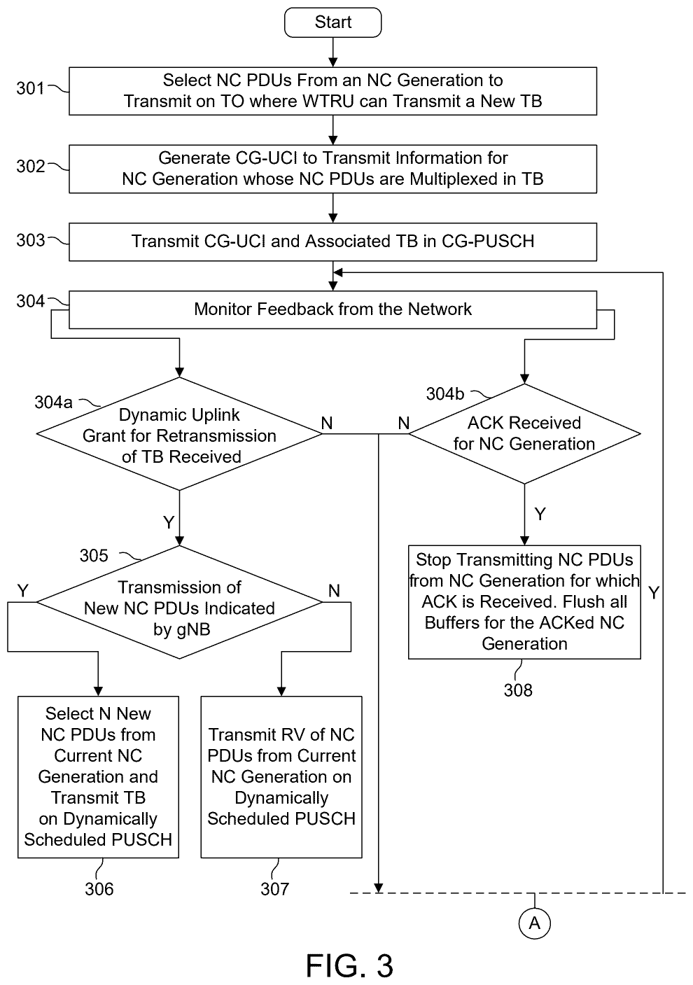

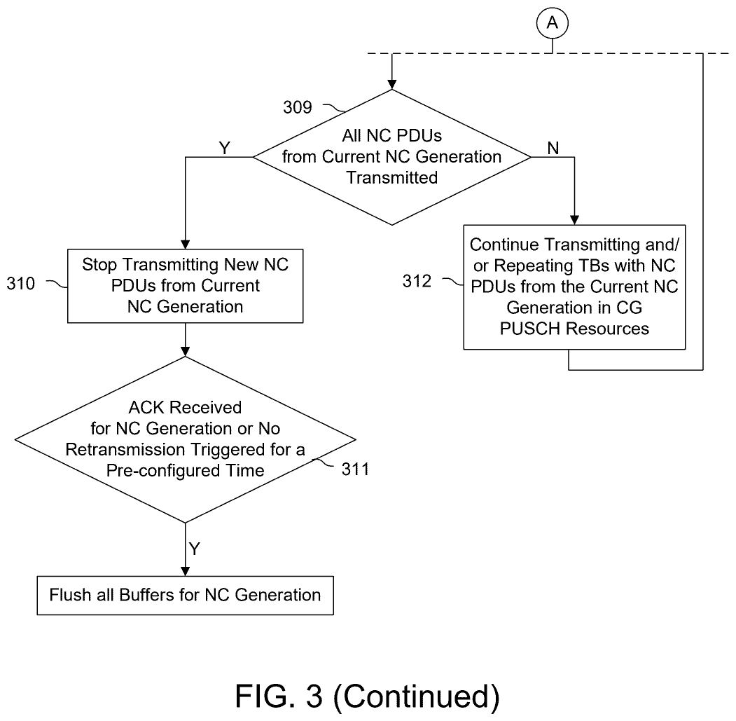

FIG. 3 is a diagram illustrating an example method for selection and transmission and/or retransmission of NC PDUs.

As shown at 301, for a CG PUSCH transmission occasion (TO), where the WTRU may transmit a new TB (e.g., for TO for RV=0), the WTRU may select one or more NC PDUs from an NC generation for multiplexing into a TB.

As shown at 302, the WTRU may generate CG-UCI to transmit NC related information to assist any of the gNB decoding, the gNB scheduling (e.g., any of trigger retransmission of NC PDUs, schedule additional NC PDU transmission etc.) and the gNB feedback decisions (e.g., indicating ACK for an NC generation). The CG-UCI may include information elements as described in the example of WTRU transmitting UCI carrying the NC related information in CG resource to assist the gNB decoding such as e.g., any of a new generation indication (NGI), a NC generation identifier for the NC generation whose NC PDUs may be multiplexed in TB for transmission on CG-PUSCH, a number of NC PDUs from the NC generation in the TB, a (e.g., minimum, lower bound) number of NC PDUs (e.g., required) for decoding of NC SDUs associated with NC generation etc.

As shown at 303, the WTRU may transmit CG-UCI and the associated TB shown at 301 with NC PDUs, in CG PUSCH TO.

As shown at 304, the WTRU may monitor the feedback for transmitted TB carrying NC PDUs from the current NC generation.

As shown at 304a, if the WTRU receives (e.g., scheduling information indicating) dynamic uplink grant for retransmission of a TB, the WTRU may determine that the TB may not have been successfully decoded at the receiver and may proceed as shown at 305.

As shown at 304b, if the WTRU receives (e.g., feedback information indicating) an ACK for the current NC generation, the WTRU may determine that the associated NC generation may have been successfully received by the gNB and may proceed as shown at 308.

As shown at 305, the WTRU may determine whether to transmit new NC PDUs or a redundancy version of the previously transmitted NC PDUs e.g., based on information (e.g., fields) in UL scheduling DCI such as any of new data indicator (NDI), RV etc., as described herein.

As shown at 306, if the WTRU receives an indication (e.g., in DCI) to transmit new NC PDUs from the NC generation, the WTRU may select a number N (as indicated in scheduling DCI) new NC PDUs from the current NC generation and may transmit the TB on dynamically scheduled PUSCH resources indicated in the received DCI as shown at 304a.

As shown at 307, if the WTRU receives an indication to retransmit the TB with an RV, the WTRU may generate a redundancy version of the NC PDUs and may transmit the TB on dynamically scheduled PUSCH resources indicated in received DCI as shown at 304a.

As shown at 308, the WTRU may stop transmitting NC PDUs from the NC generation for which (e.g., feedback information indicating an) ACK may be received as shown at 304b and may flush (e.g., all) buffers for this NC generation.

As shown at 309, the WTRU may determine if (e.g., all) the NC PDUs (Nₜₒₜₐₗ) associated with current NC generation may have been transmitted. If yes, the WTRU may proceed as shown at 310. If not, the WTRU may proceed as shown at 312.

As shown at 310, the WTRU may stop transmission of new NC PDUs from the current NC generation.

As shown at 311, the WTRU may wait for pre-configured length of time after transmission of the last TB carrying NC PDUs from the current NC generation. If no retransmission request is received, the WTRU may determine that the associated NC generation may have been successfully received by the gNB and may flush (e.g., all) buffers for this NC generation.

As shown at 312, the WTRU may continue transmitting and/or repeating TBs with NC PDUs from the current NC generation in CG PUSCH resources. The WTRU may proceed as shown at 304.

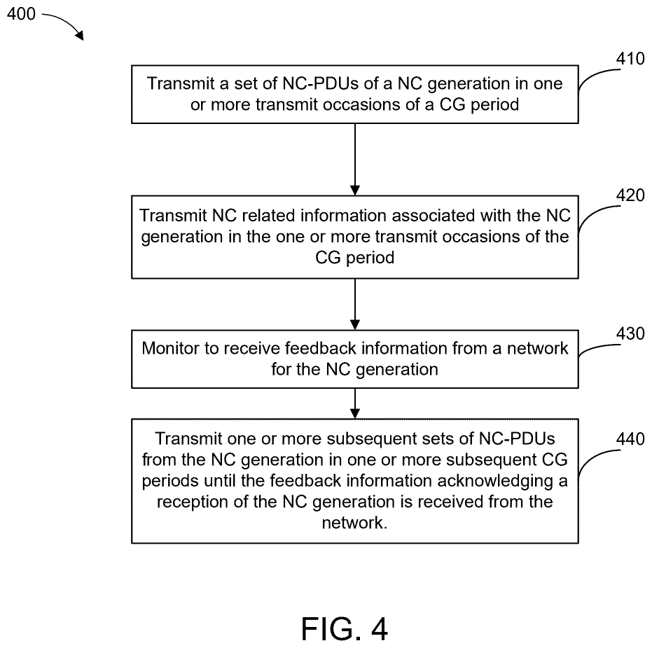

FIG. 4 is a diagram illustrating an example method 400 for CG UL HARQ operation with network coding implemented in a WTRU. The WTRU may include circuitry including any of transmitter, a receiver, a processor, and a memory. The circuitry may be configured to carry out the method 400. As shown at 410, the method 400 may include transmitting a set of NC-PDUs of a NC generation in one or more transmit occasions of a CG period. As shown at 420, the method 400 may include transmitting NC related information associated with the NC generation to assist a network in decoding. In various embodiments, the NC related information may indicate a number of NC-PDUs of the NC generation to be transmitted in the one or more transmit occasions of the CG period. As shown at 430, the method 400 may include monitoring to receive feedback information from the network for the NC generation. As shown at 440, the method 400 may include transmitting one or more subsequent sets of NC-PDUs from the NC generation in one or more subsequent CG periods until the feedback information acknowledging a reception of the NC generation may be received from the network. In various embodiments, the one or more subsequent sets of NC-PDUs may comprise different NC-PDUs from the set of transmitted NC-PDUs.

In various embodiments, transmitting the set of NC-PDUs may comprise transmitting (i) a first subset of NC-PDUs in a first transport block at a first transmit occasion of the CG period and (ii) a second subset of NC-PDUs in a second transport block at a second transmit occasion of the CG period.

In various embodiments, the NC related information may indicate a total number of NC-PDUs to be transmitted for the NC generation.

In various embodiments, the NC related information may indicate a minimum number of NC-PDUs for decoding the NC generation.

In various embodiments, the NC related information may indicate an identifier of the NC generation or a sequence number of the NC generation.

In various embodiments, the NC related information may indicate whether the set of NC-PDUs transmitted in the CG period may correspond to a new NC generation or an ongoing NC generation.

In various embodiments, transmitting the NC related information associated with the NC generation may comprise transmitting the NC related information associated with the NC generation in the one or more transmit occasions of the CG period.

In various embodiments, transmitting the NC related information associated with the NC generation may comprise transmitting the NC related information associated with the NC generation in any of uplink control information, a medium access control element and a radio resource control message.

In various embodiments, the NC generation may comprise a set of data units, and different NC-PDUs of the NC generation may be based on (e.g., a coding process performing) different linear combinations of the set of data units.

In various embodiments, a first PDU of the NC generation may be obtained based on (e.g., a coding process performing) a first linear combination of the set of data units using a first set of coefficients, and a second PDU of the NC generation may be obtained based on (e.g., a coding process performing) a second linear combination of the set of data units using a second set of coefficients different from the first set of coefficients.

In various embodiments, the method 400 may further comprise receiving configuration information indicating a repetition parameter greater than one.

In various embodiments, transmitting the one or more subsequent sets of NC-PDUs of the NC generation may comprise (1) refraining from transmitting one or more transport block repetitions based on the repetition parameter being greater than one and (2) transmitting at least a part of the one or more subsequent sets of NC-PDUs of the NC generation in replacement of the one or more transport block repetitions.

In various embodiments, the method 400 may further comprise determining whether to transmit at least a part of the one or more subsequent sets of NC-PDUs of the NC generation or to perform a repetition of at least a part of the set of NC-PDUs in a transmit occasion based on a redundancy version associated with the transmit occasion.

In various embodiments, the method 400 may further comprise determining to transmit at least a part of the one or more subsequent sets of NC-PDUs of the NC generation in the transmit occasion based on the redundancy version associated with the transmit occasion being equal to zero.

In various embodiments, the method 400 may further comprise determining to perform a repetition of at least a part of the set of NC-PDUs in the transmit occasion based on a redundancy version associated with the transmit occasion being different from zero.

In various embodiments, the feedback information may be received in any of downlink control information and a medium access control element.

In various embodiments, the feedback information may indicate of the identifier of the NC generation or the sequence number of the NC generation.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and a memory, the circuitry being operable (e.g., configured) to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A wireless transmit/receive unit (WTRU) comprising circuitry, including any of a transmitter, a receiver, a processor, and memory, configured to:
transmit a set of network coded protocol data units (NC-PDUs) of a network coding (NC) generation in one or more transmit occasions of a configured grant (CG) period, wherein the NC generation is associated with a number of more than one data units that are encoded into a plurality of NC PDUs using different linear combinations of the more than one data units, and wherein the NC generation comprises a larger number of different linear combinations of data units than the number of more than one data units;
transmit NC related information associated with the NC generation to assist a network in decoding, wherein the NC related information indicates the number of more than one data units associated with the NC generation that corresponds to a number of NC-PDUs of the NC generation to be successfully received for recovering the more than one data units;
monitor to receive feedback information from the network for the NC generation; and
transmit one or more subsequent sets of NC-PDUs from the NC generation in one or more subsequent CG periods until the feedback information acknowledging a reception of the NC generation is received from the network, wherein the one or more subsequent sets of NC-PDUs comprise at least one NC PDU of the NC generation that is a different linear combination of the more than one data units from previously transmitted linear combinations of the more than one data units.

2. The WTRU of claim 1, wherein being configured to transmit the set of NC-PDUs comprises being configured to transmit (i) a first subset of NC-PDUs in a first transport block at a first transmit occasion of the CG period and (ii) a second subset of NC-PDUs in a second transport block at a second transmit occasion of the CG period.

3. The WTRU of claim 1, wherein the NC related information indicates a total number of NC-PDUs to be transmitted for the NC generation.

4. (canceled)

5. The WTRU of claim 1, wherein the NC related information indicates an identifier of the NC generation or a sequence number of the NC generation.

6. The WTRU of claim 1, wherein the NC related information indicates whether the set of NC-PDUs transmitted in the CG period correspond to a new NC generation or an ongoing NC generation.

7. The WTRU of claim 1, wherein being configured to transmit the NC related information associated with the NC generation comprises being configured to transmit the NC related information associated with the NC generation in the one or more transmit occasions of the CG period.

8. The WTRU of claim 1, wherein being configured to transmit the NC related information associated with the NC generation comprises being configured to transmit the NC related information associated with the NC generation in any of uplink control information, a medium access control element and a radio resource control message.

9. (canceled)

10. The WTRU of claim 1, wherein a first PDU of the NC generation is obtained based on a first linear combination of the set of data units using a first set of coefficients, and a second PDU of the NC generation is obtained based on a second linear combination of the set of data units using a second set of coefficients different from the first set of coefficients.

11. The WTRU of claim 1, configured to receive configuration information indicating a repetition parameter greater than one.

12. The WTRU of claim 11, wherein being configured to transmit the one or more subsequent sets of NC-PDUs of the NC generation comprises being configured to (i) refrain from transmitting one or more transport block repetitions with different redundancy versions based on the repetition parameter being greater than one and (2) transmit at least a part of the one or more subsequent sets of NC-PDUs of the NC generation in replacement of the one or more transport block repetitions with different redundancy versions.

13. The WTRU of claim 1, configured to determine whether to transmit at least a part of the one or more subsequent sets of NC-PDUs of the NC generation or to perform a repetition of at least a part of the set of NC-PDUs in a transmit occasion based on a redundancy version associated with the transmit occasion.

14. The WTRU of claim 13, configured to determine to transmit at least a part of the one or more subsequent sets of NC-PDUs of the NC generation in the transmit occasion based on the redundancy version associated with the transmit occasion being equal to zero.

15. The WTRU of claim 13, configured to determine to perform a repetition of at least a part of the set of NC-PDUs in the transmit occasion based on a redundancy version associated with the transmit occasion being different from zero.

16. The WTRU of claim 1, wherein the feedback information is received in any of downlink control information, a medium access control element.

17. The WTRU of claim 5, wherein the feedback information indicates the identifier of the NC generation or the sequence number of the NC generation.

18. A method implemented in a wireless transmit/receive unit (WTRU), the method comprising:
transmitting a set of network coded protocol data units (NC-PDUs) of a network coding (NC) generation in one or more transmit occasions of a configured grant (CG) period, wherein the NC generation is associated with a number of more than one data units that are encoded into a plurality of NC PDUs using different linear combinations of the more than one data units, and wherein the NC generation comprises a larger number of different linear combinations of data units than the number of more than one data units;
transmitting NC related information associated with the NC generation in the one or more transmit occasions of the CG period, wherein the NC related information indicates the number of more than one data units associated with the NC generation that corresponds to a number of NC-PDUs of the NC generation to be successfully received for recovering the NC generation;
monitoring to receive feedback information from a network for the NC generation; and
transmitting one or more subsequent sets of NC-PDUs from the NC generation in one or more subsequent CG periods until the feedback information acknowledging a reception of the NC generation is received from the network, wherein the one or more subsequent sets of NC-PDUs comprise at least one NC PDU of the NC generation that is a different linear combination of the more than one data units from previously transmitted linear combinations of the more than one data units.

19. The method of claim 18, wherein the NC related information indicates a total number of NC-PDUs to be transmitted for the NC generation.

20. (canceled)

21. The WTRU of claim 1, configured to transmit remaining NC PDUs of the NC generation in dynamically scheduled resources.

22. The WTRU of claim 1, configured to retransmit NC-PDUs of the NC generation in dynamically scheduled resources.
